(19) United States
(12) Patent Application Publication
(10) Pub. No.: US 2012/0116818 A1
(43) Pub. Date: May 10, 2012

(54) COOPERATION SYSTEM AND INFORMATION TERMINAL

(76) Inventor: Yutaka Ueda, Tokyo (JP)

(21) Appl. No.: 13/382,408

(22) PCT Filed: Mar. 1, 2010
(86) PCT No.: PCT/JP2010/053192

§ 371 Date: Jan. 5, 2012

(30) Foreign Application Priority Data
Jul. 6, 2009 (JP) 2009-159465

(51) Int. Cl. G06Q 50/24

(52) U.S. Cl. 705/3

(57) ABSTRACT

Provided is a cooperation system (100) which is constituted of an information terminal (20) and a modality (30). The information terminal (20) generates cooperation information and stores the cooperation information in a predetermined storage medium. The modality (30) monitors the cooperation information stored in the storage medium. The cooperation system (100) comprises the information terminal (20) and the modality (30) connected to the information terminal (20), wherein the information terminal (20) generates the cooperation information including patient information or examination information, and the modality (30) obtains the generated cooperation information, registers the patient information or the examination information of a patient, whose image is to be taken, on the basis of the obtained cooperation information, displays a display screen at the start of the image taking, and is brought into a standby state.

### TECHNICAL FIELD

The present invention relates to a cooperation system and an information terminal.

### BACKGROUND ART

In recent years, techniques to share medical information are being developed.

Japanese Patent Laid-open Publication No. 2008-188329 discloses a technique to record medical information obtained by a medical institute, such as medical images, in a medium so as to allow another medical institute to easily browse the same medical information. According to this technique, different medical institutes can share medical information.

In medical sites, staff are very busy, and a small mistake could lead to a significant problem. Accordingly, such cooperation as described above can reduce the burden on healthcare workers and is very effective on preventing mistakes.

### PRIOR ART DOCUMENTS

### Patent Literatures

Patent Literature 1: Japanese Patent Laid-open Publication No. 2008-188329

### SUMMARY OF INVENTION

### Problems to be Solved by the Invention

However, Japanese Patent Laid-open Publication No. 2008-188329 does not describe as to cooperation before medical images are created. Before medical images are created, the following series of processes are performed.

(1) At a terminal (a receipt computer) placed in a reception room, patient information is registered. The registration of the patient information is performed by a receptionist.
(2) At a modality placed in an examination room, patient information is registered, and medical images of patients are generated by the modality. The registration of the patient information is performed by an examiner.
(3) At an information terminal placed in a consultation room, the generated medical images are viewed. The viewing of the medical images is performed by a doctor or a doctor specializing in interpreting radiograms.

At large-scale medical institutes, the above steps (1) to (3) are individually assigned to specialized staffs to be processed, and there is no significant problem.

At small-scale medical institutes, however, the above steps (1) to (3) are processed by one or a very few doctors. These steps are individually processed by specific terminals/devices which are not in cooperation, and doctors need to perform troublesome operations of entering the same patient information and the same examination information many times for the individual steps.

Moreover, terminals/apparatuses which are not in use are turned off for electricity conservation. Each time the doctor uses a terminal/apparatus, the doctor needs to turn on the terminal/apparatus and wait for the terminal/apparatus to be activated. This reduces the work efficiency.

An object of the invention is to provide a cooperation system including an information terminal generating cooperation information and a modality which registers patient information or examination information based on the cooperation information.

### Solutions to Problems

According to the present invention, provided is a cooperation system, comprising:

an information terminal; and

a modality connected to the information terminal, wherein

the information terminal generates cooperation information including patient information or examination information, and

the modality obtains the generated cooperation information; registers the patient information or examination information of a patient as a capturing target object based on the obtained cooperation information; and stands by with a start screen of image capturing being displayed.

According to the present invention, provided is an information terminal, comprising:

an image import button which obtains a medical image of a patient to be captured;

a communication unit connected to a modality; and

a controller which checks whether power supply of the modality is on when the image import button is pressed; and when the power supply is not on, turns on the power supply of the modality by a power supply cooperation command; and stores cooperation information including patient information or examination information of the patient as a capturing target object.

### Advantageous Effect of Invention

According to the present invention, the information terminal can generate cooperation information. The modality can automatically register patient information or examination information based on the cooperation information and can keep displaying a start screen of image capturing. This can save the effort of entering again at the modality, the patient information or the like which is once entered/checked at a receipt computer or an information terminal, and therefore can immediately start capturing an image. It is therefore possible to reduce troublesome works and prevent incorrect input.

### BRIEF DESCRIPTION OF DRAWINGS

FIG. 1 is an entire configuration view of a cooperation system.

FIG. 2 is a functional block diagram of an information terminal.

FIG. 3 is a view showing a screen example.

FIG. 4 is a view showing a screen example.

FIG. 5 is a view showing a screen example.

FIG. 6 is a flowchart showing a first cooperation process.

FIG. 7 is a conceptual view of the cooperation process.

FIG. 8 is a flowchart showing a second cooperation process.

FIG. 9 is a flowchart showing a third cooperation process.

### DESCRIPTION OF EMBODIMENTS

A description is given of the configuration and operation of a cooperation system of this embodiment in detail using the drawings. The embodiment is an example of the invention, and the invention is not limited to this.

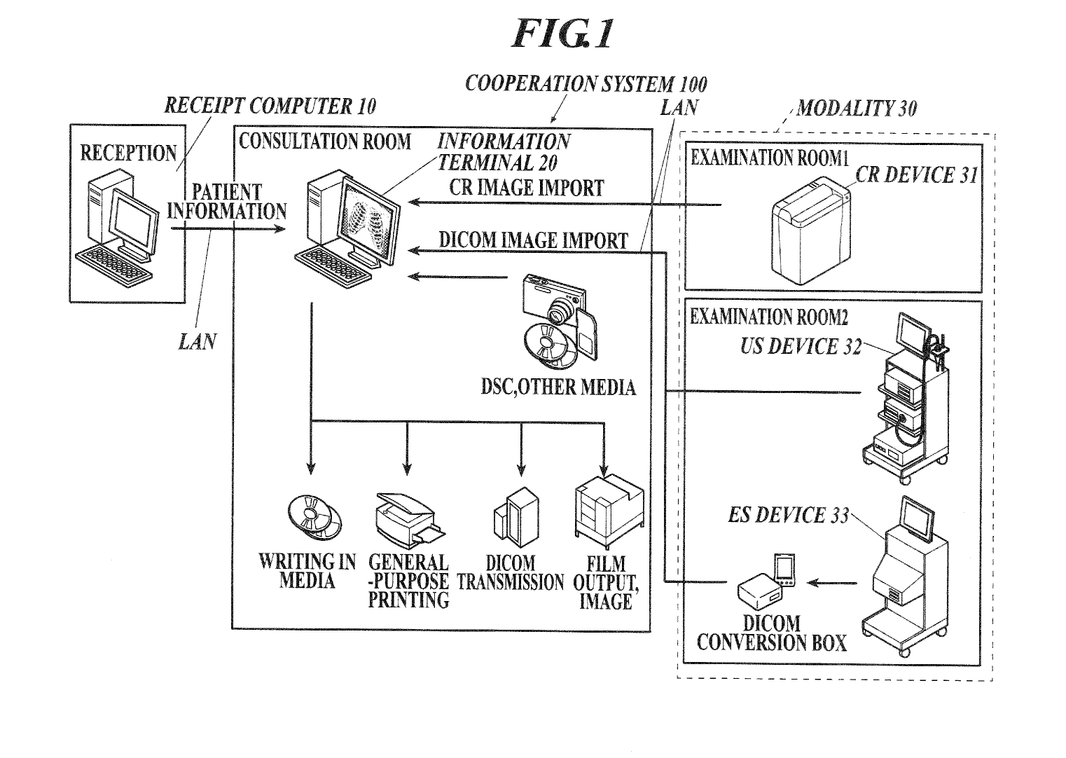

FIG. 1 shows a configuration of a cooperation system. 100.

The cooperation system 100 includes a receipt computer 10, an information terminal 20, a modality 30, and the like.

The devices (10 to 30) are connected through a LAN so as to communicate with each other. The communication standard thereof is HL7 or DICOM MWM (Modality Worklist Management), for example.

The receipt computer 10 is a general PC (personal computer).

The receipt computer 10 is installed in a reception room. The receipt computer 10 registers patient information and transmits the registered patient information to the information terminal 20 or modality 30.

The patient information is information which includes patient IDs, names, dates of birth, and sexes of patients and the like, to specify patients.

The information terminal 20 is a terminal including functions as a general PC and moreover including functions of obtaining/managing medical images and the like.

The information terminal 20 receives or registers the patient information and receives or registers examination information.

The examination information is information which includes examination IDs, examination modes, probe types (only for ultrasound examination), image processing parameters, and the like, to specify examinations.

The information terminal 20 is installed in a consultation room and outputs the patient or examination information (hereinafter, referred to as cooperation information) to a shared folder.

The shared folder may be included in the information terminal 20 or may be included in a storage medium which is connected to the LAN and is externally installed.

In FIG. 1, one information terminal 20 is installed in the consultation room, but not limited to this. Two information terminals 20 may be installed in the consultation room, or one of the two information terminals 20 may be installed in the examination room, for example.

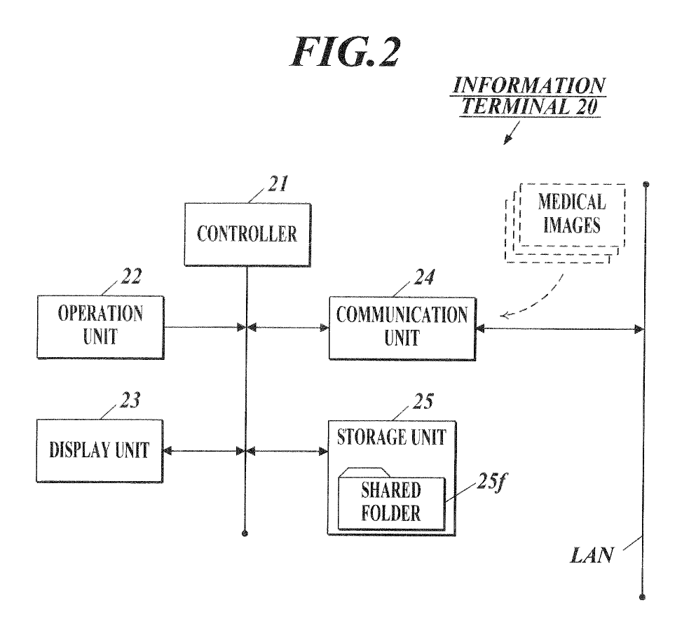

FIG. 2 shows a functional configuration of the information terminal 20.

The information terminal 20 includes a controller 21, an operation unit 22, a display unit 23, a communication unit 24, a storage unit 25, and the like.

The controller 21 includes a CPU (central processing unit), a RAM (random access memory), and the like.

The controller 21 performs various calculations in cooperation with a program stored in the storage unit 25 and centrally controls the operation of each unit (22 to 25).

The operation unit 22 includes a keyboard, a mouse, and the like.

The operation unit 22 is operated by a user to generate an operation signal and outputs the generated operation signal to the controller 21.

The display unit 23 includes a display and the like and displays various operation screens and medical images according to display control by the controller 21.

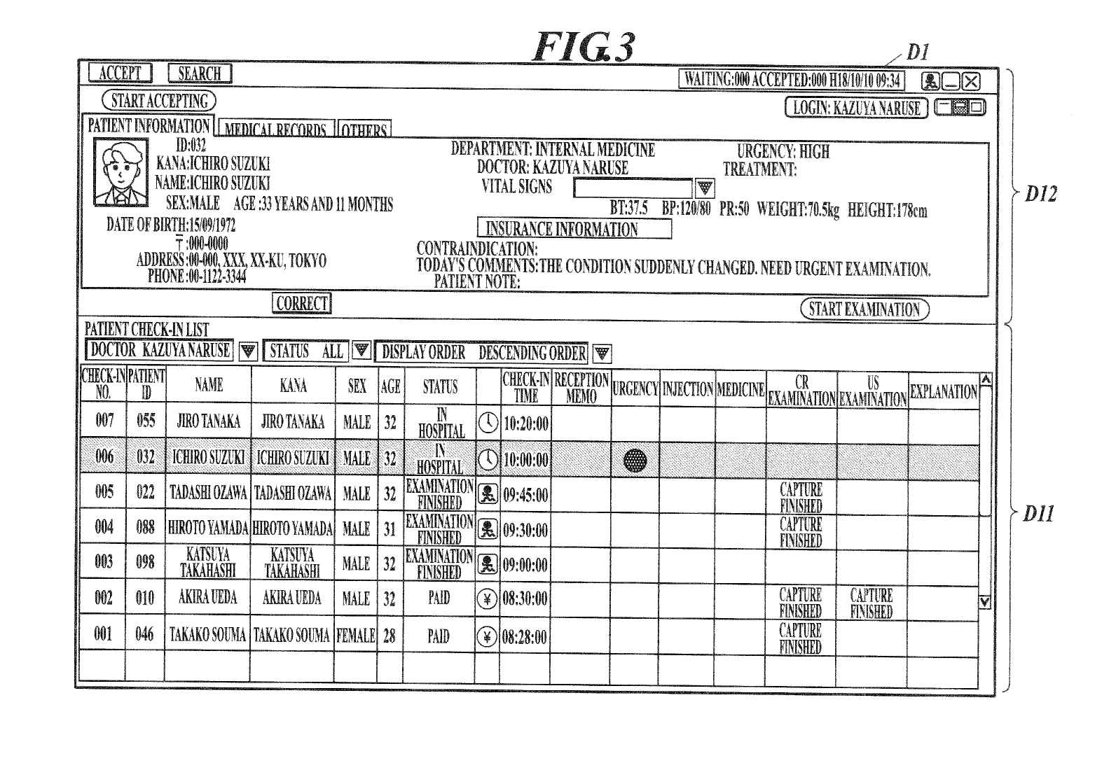

FIGS. 3 to 5 show displayed screen examples.

A screen D1 of FIG. 3 is a list screen showing patient information registered by the receipt computer 10. The same screen is displayed also at the receipt computer 10.

In a lower region D11 of the screen D1, a list of the patient information transmitted from the receipt computer 10 is displayed.

In an upper region D12 of the screen D1, detailed patient information of one patient selected in the region D11 is displayed.

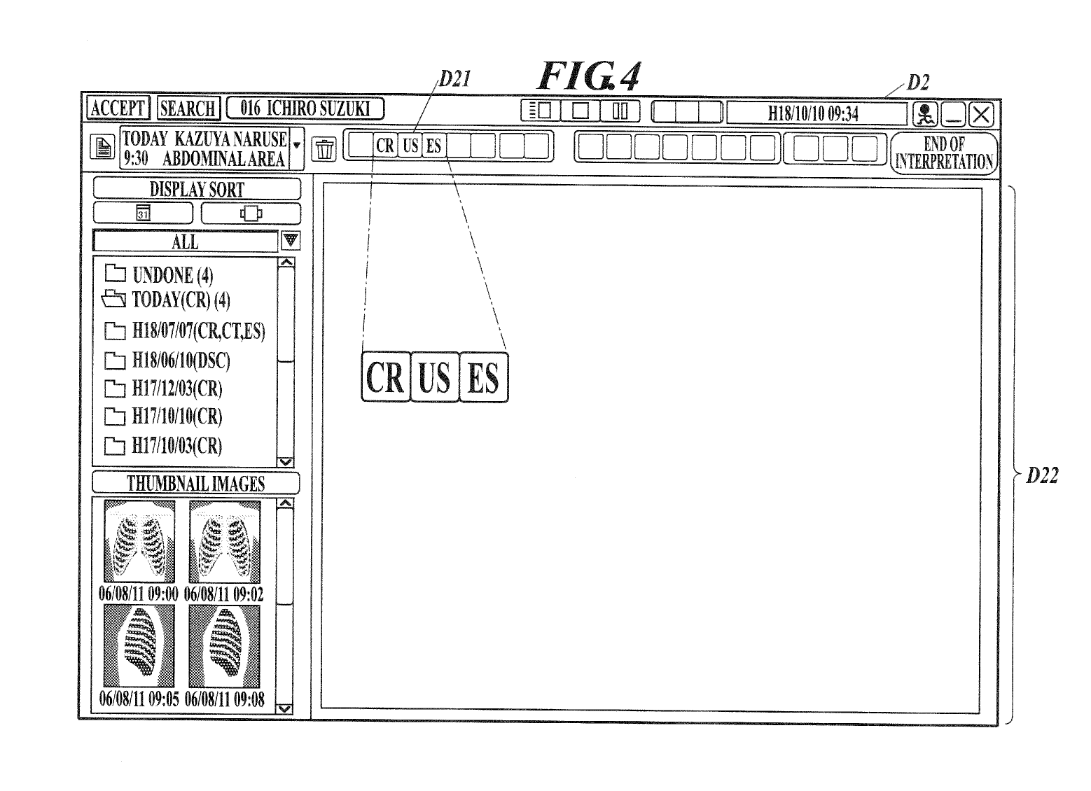

A screen D2 of FIG. 4 is a viewer screen for a patient selected in the screen D1.

In a region D21 located in an upper part of the screen D2, buttons indicating the kinds of modalities are displayed. The buttons in the region D21 function as image import buttons.

When one of the buttons in the region D21 (for example, US) is pressed, a medical image taken by an ultrasonographic device (US device) is displayed.

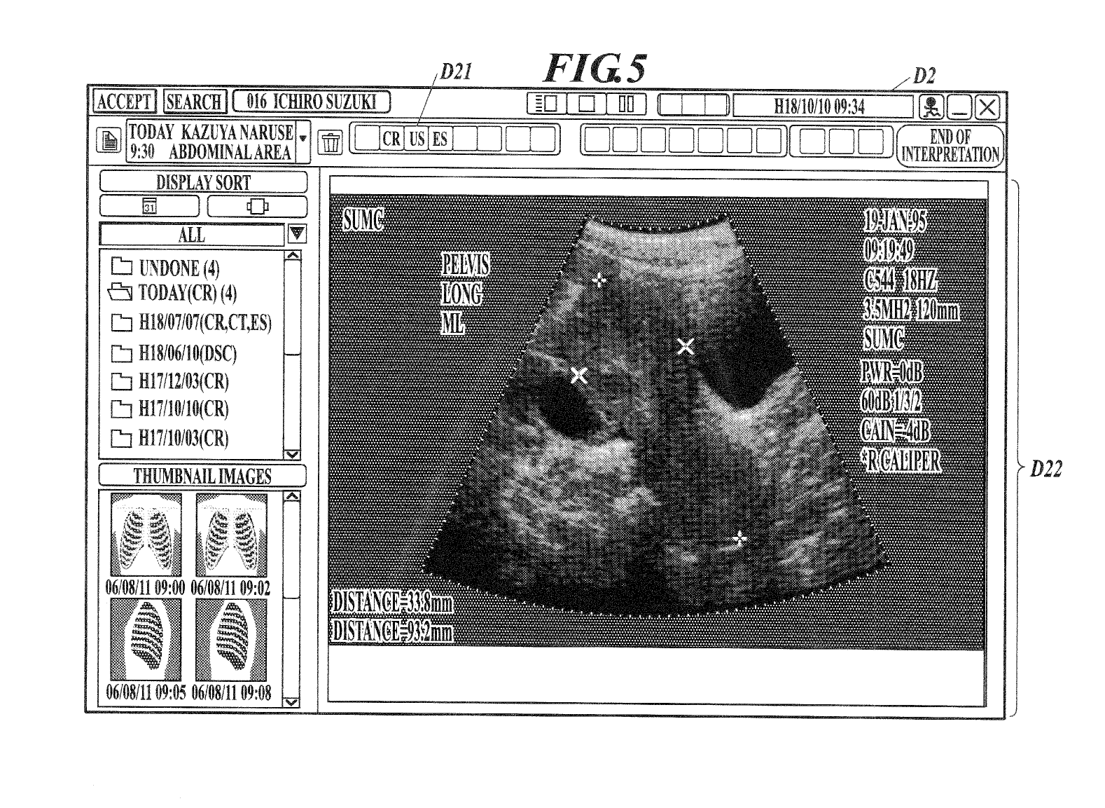

A screen D3 of FIG. 5 is a viewer screen for a patient displayed when the image import button of the region D21 is pressed to import a medical image.

Back in FIG. 2, the communication unit 24 includes an interface for communication and the like.

The communication unit 24 receives the patient information from the receipt computer 10 installed on the same network. The communication unit 24 receives a medical image from the modality 30.

The storage unit 25 includes a non-volatile semiconductor memory such as a ROM (read only memory).

The storage unit 25 stores a system program and various processing programs and stores data obtained by the various processing programs. The storage unit 25 stores the medical image received by the communication unit 24.

The storage unit 25 includes a shared folder 25f.

The shared folder 25f stores cooperation information generated by the controller 21.

Back in FIG. 1, the modality 30 is an apparatus which captures a medical image, such as a computed radiographic device (a CR device) 31, an ultrasonographic device (a US device) 32, and an endoscope device (an ES device) 33.

The modality 30 is installed in an examination room 1 or 2.

The modality 30 displays a start screen of image capturing in a not-shown display unit based on the cooperation information stored by the information terminal 20 in the shared folder 25f, and stands by.

At normal time, the start screen of image capturing is displayed after the patient information and examination information are input by user's operation.

The modality 30 captures an image of a patient in an image capture screen and transmits the obtained medical image to the information terminal 20.

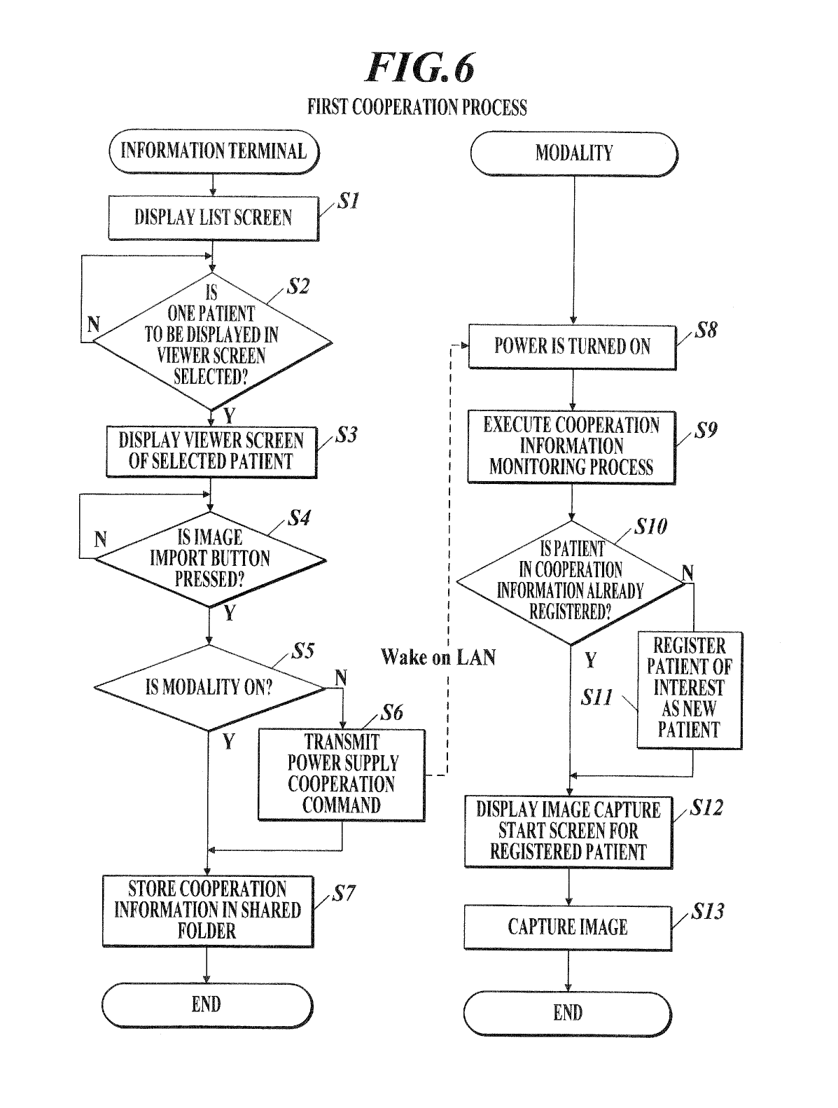

With reference to FIG. 6, a first cooperation process is described.

First, the process of the information terminal 20 is described.

The controller 21 displays a list screen (D1 in FIG. 3) in the display unit 23 (step S1).

The controller 21 then judges whether one of patients to be displayed in the viewer screen (D2 in FIG. 4) is selected (step S2).

If no patient is selected (N in the step S2), the controller 21 keeps displaying the list screen.

If a patient is selected (Y in the step S2), the controller 21 displays a viewer screen for the selected patient (step S3).

In the viewer screen displayed in the step S3, a medical image for the patient is not displayed yet. The medical image for the patient is displayed in the viewer screen when the image import button (S21 in FIG. 4) is pressed.

The controller 21 judges whether any one of the image import buttons is pressed (step S4).

If no button is pressed (N in the step S4), the controller 21 keeps displaying the viewer image.

If one of the buttons is pressed (Y in the step S4), the controller 21 judges whether the power supply of the modality 30 is on (step S5).

Whether the power supply of the modality 30 is on is judged by using a command such as a ping or ACK. Alternatively, such determination may be performed by using a special protocol set in advance between the information terminal 20 and modality 30.

When the power supply of the modality 30 is not on (N in the step S5), the controller 21 transmits a power supply cooperation command (Wake on LAN) to the modality 30 (step S6).

After transmitting the command, the controller 21 proceeds to step S7.

When the power supply of the modality 30 is on (Y in the step S5), the controller 21 stores the cooperation information in the shared folder 25f (step S7), and the processing of the information terminal 20 is terminated.

Note that, as described above, the cooperation information is information including patient information or examination information.

Next, the processing of the modality 30 is described.

Herein, the description is given of a case where the power supply of the modality 30 is off before the processing starts.

The modality 30 receives the power supply cooperation command to be turned on (step S8).

The modality 30 constantly executes a cooperation information monitoring process when the power supply of the modality 30 is on (step S9).

By the cooperation information monitoring process, the modality 30 obtains the predetermined cooperation information stored in the shared folder 25f according to the path of the shared folder 25f.

The modality 30 judges whether a patient registered as a capturing target object in the cooperation information is registered also in the modality 30 (step S10).

When the patient registered in the cooperation information is not registered in the modality 30 (N in the step S10), the modality 30 registers the patient specified in the cooperation information as a new patient (step S11).

After the registration, the modality 30 proceeds to step S12.

If the patient registered in the cooperation information is already registered in the modality 30 (Y in the step S10), the modality 30 displays the start screen of image capturing for the registered patient in the not-shown display unit (step S12).

As described above, the start screen of image capturing is a screen displayed after the patient or examination information is entered and registered at the modality 30 by the user.

Herein, the modality 30 automatically enters the patient or examination information and displays the image capture screen based on the cooperation information.

The modality 30 keeps displaying the start screen of image capturing and captures an image when a predetermined image capture button or the like is pressed (step S13). The processing of the modality 30 is thus terminated.

Hereinabove, the cooperation system 100 terminates the first cooperation process.

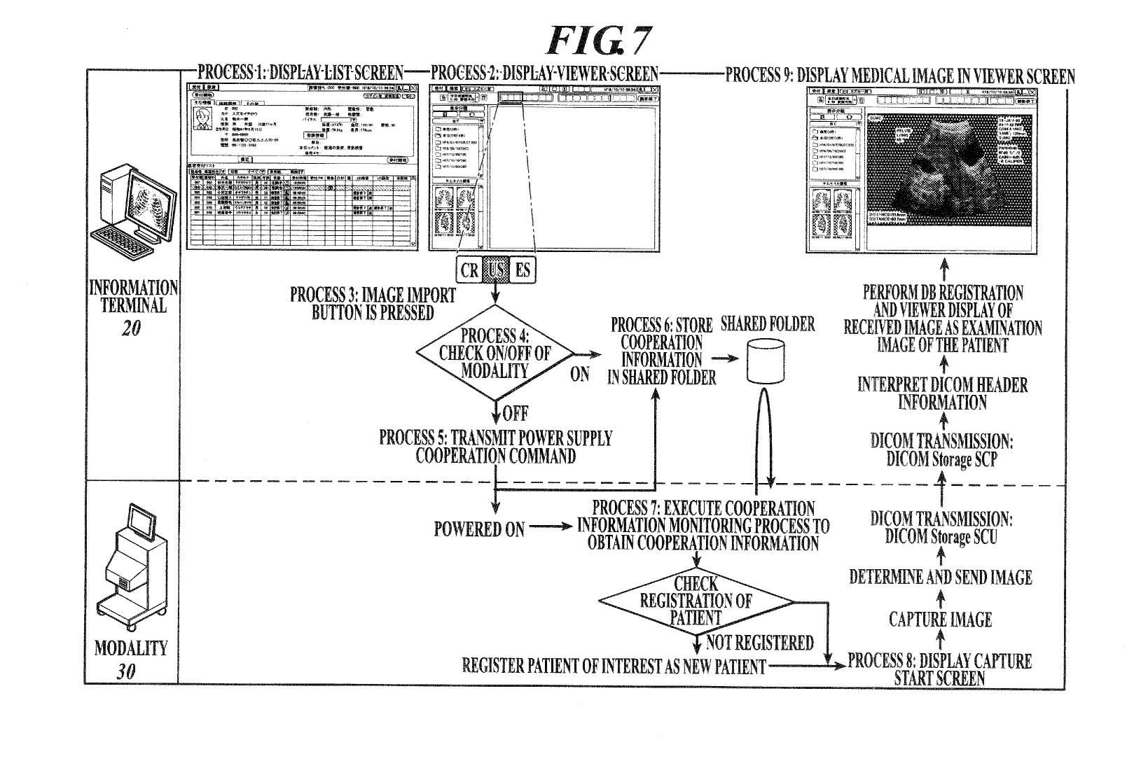

FIG. 7 shows a conceptual view of the first cooperation process.

At first, a description is given of processes (1 to 6) of the information terminal 20.

In the information terminal 20, the list screen is displayed (process 1). When one patient is selected, the display is changed to the viewer screen (process 2).

Next, when the image import button (the US button herein) is pressed (process 3), it is checked whether the power supply of the modality 30 is on or off (process 4).

When the power supply to the modality 30 is off, the power supply cooperation command is transmitted (process 5), and the cooperation information is output to the shared folder 25f (process 6).

Next, a description is given of processes (7, 8) of the modality 30.

In the modality 30, when the power supply to the modality 30 is off, the power supply cooperation command is received to turn on the power supply of the modality 30.

The cooperation information monitoring process is executed, and the cooperation information is obtained (process 7).

After the registration of patients is confirmed, the start screen of image capturing is displayed for the patient as a target object (process 8).

Thereafter, image capture is performed, and fixed medical image is transmitted to the information terminal 20.

In the information terminal 20, the medical image is received, or the patient information is confirmed. Eventually, the medical image is displayed on the viewer screen (process 9).

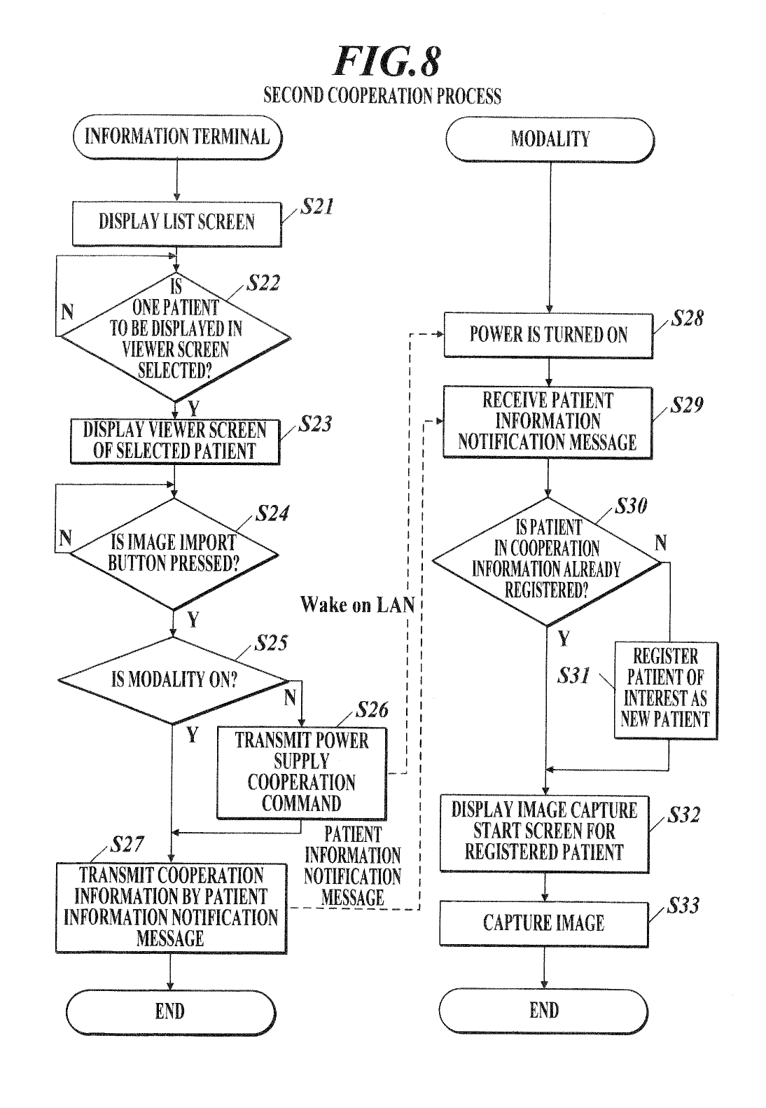

With reference to FIG. 8, a second cooperation process is described.

The second cooperation process differs from the first cooperation process in that the information terminal 20 uses a patient information notification message to transmit the cooperation information to the modality 30.

Hereinafter, specific processing thereof is described.

Steps S21 to S26 are the same as the steps S1 to S6 in the first cooperation process, respectively, and the description thereof is omitted.

The controller 21 transmits the cooperation information to the modality 30 by the patient information notification message (step S27).

The patient information notification message is an HL7 ADT message, for example. HL7 is a standard format used to exchange electronic data of healthcare-related information between different systems.

Using the HL7 ADT message, the cooperation information can be exchanged between different systems (between the information terminal 20 and modality 30 herein).

The modality 30 receives the power supply cooperation command to be turned on (step S28) and then receives the patient information notification message (step S29).

Upon receiving the HL7 ADT message, the modality 30 transmits an HL7 ACK message (a patient information notification acknowledge message) to the information terminal 20.

Steps S30 to S33 are the same as the steps S10 to S13 of the first cooperation process, respectively, and the description thereof is omitted.

Hereinabove, the cooperation sytsem100 terminates the second cooperation processing.

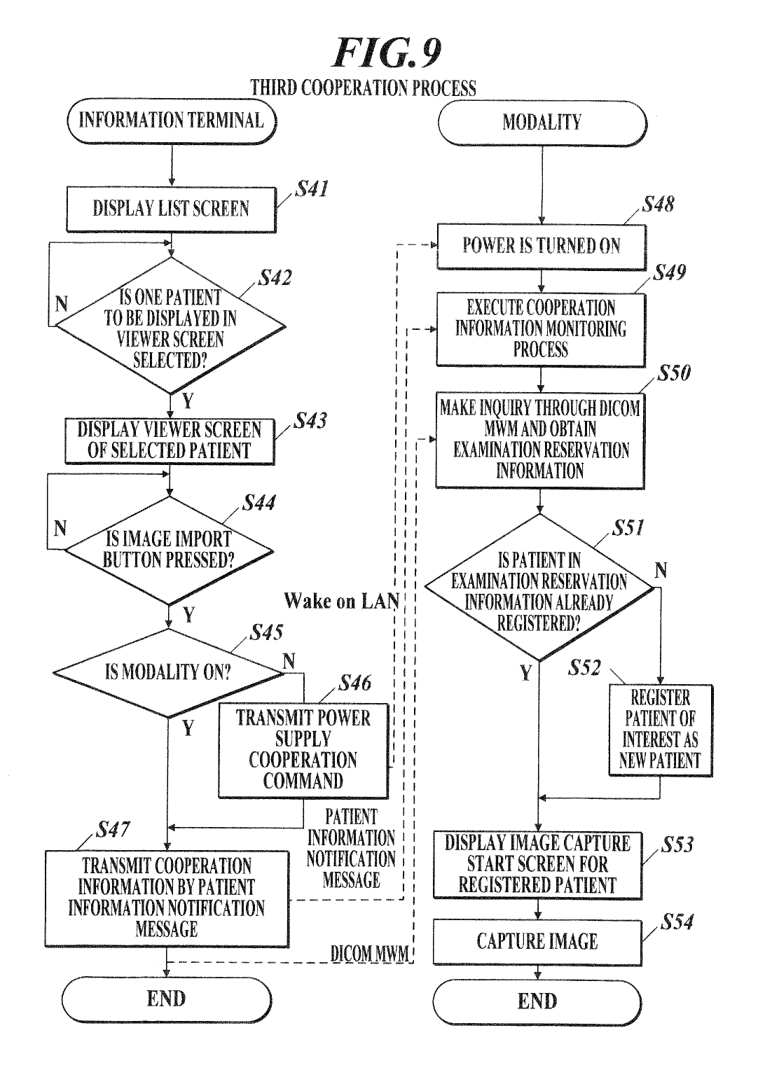

With reference to FIG. 9, a description is given of a third cooperation process.

The third cooperation process is the same as the first cooperation process in that the information terminal 20 outputs the cooperation information to the shared folder 25f and differs from the first cooperation process in that the modality 30 inquires examination reservation information by DICOM MWM. Hereinafter, the processing thereof is described in detail.

Steps S41 to S49 are the same process as the steps S1 to S9 of the first cooperation process, respectively, and the description thereof is omitted.

The modality 30 makes an inquiry by DICOM MWM, and obtains the examination reservation information from the information terminal 20 (step S50).

The modality 30 judges whether the patient registered in the obtained examination reservation information is registered also in the modality 30 (step S51).

Steps S52 to S54 are the same as the steps S11 to S13 of the first cooperation processing, respectively, and the description thereof is omitted.

The cooperation system 100 thus terminates the third cooperation processing.

As described above, according to the embodiment, the information terminal 20 can generate cooperation information. On the other hand, the modality 30 can automatically register the patient or examination information of a patient as a capturing target object based on the cooperation information and can stand by with the start screen of image capturing being displayed.

Moreover, the information terminal 20 can turn on the power supply of the modality 30 at the time of importing a medical image.

Furthermore, when importing a medical image, the information terminal 20 can store the cooperation information in the shared folder 25f. On the other hand, the modality 30 can obtain the cooperation information from the shared folder 25f.

Still furthermore, the information terminal 20 can cause the modality 30 to obtain examination reservation information according to an inquiry from the modality 30. On the other hand, the modality 30 can automatically register the patient or examination information of a patient as a capturing target object based on the examination reservation information and cooperation information and can stand by with the start screen of image capturing being displayed.

Still furthermore, when importing a medical image, the information terminal 20 can cause the modality 30 to obtain the cooperation information through a patient notification message (HL7 ADT message). On the other hand, the modality 30 can obtain the cooperation information by the patient notification message.

The patient information is information including at least one or all of the patient ID, name, date of birth, and sex. The examination information is information including at least one or all of the examination ID, examination mode, probe type, and image processing parameter. The examination information may include other information.

### INDUSTRIAL APPLICABILITY

The invention can be used in the medical field and can be applied to information terminals including a function to obtain/manage medical images. Moreover, the invention is applicable to a cooperation system including the information terminal and modality connected to each other.

### REFERENCE SIGNS LIST

100: COOPERATION SYSTEM
10: RECEIPT COMPUTER
20: INFORMATION TERMINAL
21: CONTROLLER
22: OPERATION UNIT
23: DISPLAY UNIT
24: COMMUNICATION UNIT
25: STORAGE UNIT
25f: SHARED FOLDER
30: MODALITY

1. A cooperation system, comprising:
an information terminal; and
a modality connected to the information terminal, wherein
the information terminal generates cooperation information including patient information or examination information, and
the modality obtains the generated cooperation information; registers the patient information or examination information of a patient as a capturing target object based on the obtained cooperation information; and stands by with an start screen of image capturing being displayed.

2. The cooperation system according to claim 1, wherein when importing a medical image, the information terminal checks whether power supply of the modality is on, and when the power supply is not on, the information terminal turns on the power supply by a power supply cooperation command.

3. The cooperation system according to claim 1, wherein
the information terminal stores the cooperation information in a shared folder when importing a medical image, and
the modality constantly monitors the shared folder when the power supply of the modality is on; obtains stored cooperation information when the cooperation information is stored in the shared folder; registers the patient information or examination information of a patient as a capturing target object based on the obtained cooperation information; and stands by with the start screen of image capturing being displayed.

4. The cooperation system according to claim 1 wherein
the information terminal causes the modality to obtain examination reservation information according to an inquiry from the modality, and
the modality obtains the examination reservation information;
registers the patient information or examination information of the patient as a capturing target object based on the obtained examination reservation information and the cooperation information; and stands by with an start screen of image capturing being displayed.

5. The cooperation system according to claim 1, wherein
when importing a medical image, the information terminal causes the modality to obtain the cooperation information by a patient information notification message, and
the modality obtains the cooperation information; registers the patient information or examination information of the patient as a capturing target object based on the obtained cooperation information; and stands by with the start screen of image capturing being displayed.

6. The cooperation system according to claim 1, wherein
the patient information includes at least one or all of a patient ID, a name, a date of birth, and a sex of a patient to be captured by the modality, and
the examination information includes at least one or all of an examination ID, an examination mode, a probe type, and an image processing parameter for an image to be capture by the modality.

7. An information terminal, comprising:
an image import button which obtains a medical image of a patient to be captured;
a communication unit connected to a modality; and
a controller which checks whether power supply of the modality is on when the image import button is pressed; and when the power supply is not on, turns on the power supply of the modality by a power supply cooperation command; and stores cooperation information including patient information or examination information of the patient as a capturing target object.

8. The information terminal according to claim 7, wherein the controller causes the modality to obtain examination reservation information according to an inquiry from the modality.

9. The information terminal according to claim 7, wherein the controller causes the modality to obtain the cooperation information by a patient information notification message when the image import button is pressed.

10. The information terminal according to claim 7, wherein
the patient information includes at least one or all of a patient ID, a name, a date of birth, and a sex of a patient to be captured by the modality, and
the examination information includes at least one or all of an examination ID, an examination mode, a probe type, and an image processing parameter for an image to be captured by the modality.
